(19) United States
(12) Patent Application Publication
(10) Pub. No.: US 2026/0330021 A1
(43) Pub. Date: Oct. 22, 2026

(54) ARTIFICAL INTELLIGENCE AND MACHINE LEARNING FOR CYBERSECURITY

(71) Applicant: INTERNATIONAL BUSINESS MACHINES CORPORATION, Armonk, NY (US)

(72) Inventors: Zbigniew Jan BOROWSKI, Marietta, GA (US); Sudhamsh KALACHAVEEDU, Bangalore (IN); Diana CABRERA, Flower Mound, TX (US); Lijing ZHANG, Little Elm, TX (US)

(21) Appl. No.: 19/180,646

(22) Filed: Apr. 16, 2025

(51) Int. Cl. G06F 21/57

(52) U.S. Cl. CPC G06F 21/577; G06F 2221/034

(57) ABSTRACT

Computer implemented methods, systems, and computer program products include program code executing on a processor(s) which ingests input data; the input data comprises requirements and standards for the computing architecture. The program code identifies categorical variables in the input data by applying a machine learning algorithm which utilizes the relevant categorical variables to determine common controls in the input data. The program code generates a recommendation for a base control set for the computing architecture. The program code generates the base control set and solution requirement specifications. The program code determines, based on comparing the solution requirement specifications to a reference solution pattern repository, if a solution in the reference solution pattern repository satisfies the base control.

### BACKGROUND

One or more aspects relate, in general, to facilitating cybersecurity compliance within a computing environment, and in particular, to automate information technology (IT) system design in compliance with cybersecurity standards, including for shared computing environments.

Artificial intelligence (AI) refers to intelligence exhibited by machines. Artificial intelligence (AI) research includes search and mathematical optimization, neural networks, and probability. Artificial intelligence (AI) solutions involve features derived from research in a variety of different science and technology disciplines ranging from computer science, mathematics, psychology, linguistics, statistics, and neuroscience. Machine learning has been described as the field of study that gives computers the ability to learn without being explicitly programmed.

Zero Trust is an example of a cybersecurity specification. There are different definition for this example across the cybersecurity and computing industries, but one such definition describes a Zero Trust specification as preventing damage to, engaging in the protection of, and the restoration of computers, electronic communications systems, electronic communications services, wire communication, and electronic communication, including information contained therein, to ensure its availability, integrity, authentications, confidentiality, and nonrepudiation.

### SUMMARY

Shortcomings of the prior art are overcome, and additional advantages are provided through the provision of a computer-implemented method for generating a compliant system design for a computing architecture. The method includes ingesting, by one or more processors, input data, wherein the input data comprises requirements and standards for the computing architecture; identifying, by the one or more processors, relevant categorical variables in the input data by applying a machine learning algorithm, wherein the machine learning algorithm utilizes the relevant categorical variables to determine common controls in the input data; generating, by the one or more processors, based on the common controls, a recommendation for a base control set for the computing architecture; generating, by the one or more processors, based on the recommendation, the base control set and solution requirement specifications; and determining, by the one or more processors, based on comparing the solution requirement specifications to a reference solution pattern repository, if a solution in the reference solution pattern repository satisfies the base control.

Shortcomings of the prior art are overcome, and additional advantages are provided through the provision of a computer program product for generating a compliant system design for a computing architecture. The computer program product comprises a storage medium readable by a one or more processors and storing instructions for execution by the one or more processors for performing a method. The method includes, for instance: ingesting, by the one or more processors, input data, wherein the input data comprises requirements and standards for the computing architecture; identifying, by the one or more processors, relevant categorical variables in the input data by applying a machine learning algorithm, wherein the machine learning algorithm utilizes the relevant categorical variables to determine common controls in the input data; generating, by the one or more processors, based on the common controls, a recommendation for a base control set for the computing architecture; generating, by the one or more processors, based on the recommendation, the base control set and solution requirement specifications; and determining, by the one or more processors, based on comparing the solution requirement specifications to a reference solution pattern repository, if a solution in the reference solution pattern repository satisfies the base control.

Shortcomings of the prior art are overcome, and additional advantages are provided through the provision of a system for generating a compliant system design for a computing architecture. The system includes: a memory, one or more processors in communication with the memory, and program instructions executable by the one or more processors via the memory to perform a method. The method can include for instance: ingesting, by the one or more processors, input data, wherein the input data comprises requirements and standards for the computing architecture; identifying, by the one or more processors, relevant categorical variables in the input data by applying a machine learning algorithm, wherein the machine learning algorithm utilizes the relevant categorical variables to determine common controls in the input data; generating, by the one or more processors, based on the common controls, a recommendation for a base control set for the computing architecture; generating, by the one or more processors, based on the recommendation, the base control set and solution requirement specifications; and determining, by the one or more processors, based on comparing the solution requirement specifications to a reference solution pattern repository, if a solution in the reference solution pattern repository satisfies the base control.

Computer systems and computer program products relating to one or more aspects are also described and may be claimed herein. Further, services relating to one or more aspects are also described and may be claimed herein.

Additional aspects of the present disclosure are directed to systems and computer program products configured to perform the methods described above. Additional features and advantages are realized through the techniques described herein. Other embodiments and aspects are described in detail herein and are considered a part of the claimed aspects.

### BRIEF DESCRIPTION OF THE DRAWINGS

One or more aspects are particularly pointed out and distinctly claimed as examples in the claims at the conclusion of the specification. The foregoing and objects, features, and advantages of one or more aspects are apparent from the following detailed description taken in conjunction with the accompanying drawings in which:

FIG. 1 depicts one example of a computing environment to perform, include and/or use one or more aspects of the present disclosure;

FIG. 2 is a workflow that illustrates various aspects of some examples in the present disclosure;

FIG. 3 is a component diagram that illustrates interactions between various architectural elements of some examples of the preset disclosure;

FIG. 4 depicts a machine learning system that is an aspect of some examples of the present disclosure;

FIG. 5 is a workflow that illustrates various aspects of some examples in the present disclosure; and

FIG. 6 is a workflow that illustrates various aspects of some examples in the present disclosure.

### DETAILED DESCRIPTION

The computer-implemented methods, computer program products, and systems described herein can generate an intelligent workflow. In some examples, program code executing on one or more processors receives and processes various data and utilizes these data to automatically design and information technology (IT) system. As will be described in greater detail herein, the program code can apply AI methods including but not limited to machine learning (ML) (e.g., an AI/ML engine) to the data to generate a (e.g., common) base security control set and a feature store for the IT system. The program code can optimize this base security control set generate a tailored or custom control set using a solutioning blueprint and/or references from a solution pattern repository. The program code automatically generates the IT system it designed. This finished product can include various components. The program code utilizes the aforementioned AI methods (e.g., the AI/ML engine) to identify these components. The components fulfill system features and security requirements. The program code can store details corresponding to each of the plurality of components in a database in a predefined format. In some examples, the data obtained by the program code and utilized by the program code to design and generate the IT system includes one or more of: customer requirements of the IT system, industry standards and protocols of the IT system, and security and compliance requirements of the IT system.

As will be discussed in greater detail herein, computer-implemented methods, computer program products, and systems described herein can design a security infrastructure for a computing system. As such, program code executing on one or more processors can obtain functional and security requirements to be addressed in the design. Based on the data received (the functional and security requirements), the program code can generate a common control set and a system specification. Requirements can include, but are not limited to, define and implement security policies, provide risk and compliance service, provide risk and compliance product, provide risk profiling capability, provide security education, provide audit and regulatory service, provide application and security testing service, provide cluster security, provide container register security, provide container security runtime, provide container security image scanning, provide container security registry tool, provide container platform computer resource, provide data loss prevention solution, provide data access and integrity monitoring, secure data and files at rest, secure host and service communication, and provide database solution. The common control set and the specification comprise a design baseline for the system. The program code then refines this baseline. For example, the program code can verify, utilizing a reference pattern repository, existing solutions to be reused in the design and that define the baseline. The program code can enhance the common control set utilizing a solution blueprint to generate a tailored control set. This tailored control set can be understood as a baseline for a final design. The program code can generate a design relevancy score by applying a machine learning algorithm (which the program code can train) to recommend a relevant solution pattern. The machine learning algorithm is trained to identify associations and correlations. The program code, with the assistance of the machine learning algorithm, identifies a system architecture with the highest relevancy score. The program code determines logical design components and corresponding security and compliance specifications based on this system architecture. In some examples, the program code can utilize subject matter experts (SMEs) to verify both preliminary and target designs. The program code can generate a final design. The final design complies with applicable security controls, and that defines both logical and physical system components that include specific products, technologies and services.

Certain examples described herein include computer implemented methods, computer program products, and computer systems where program code executed by one or more processors implements a cognitive system that includes machine learning. The program code obtains input, which can include customer requirements formatted as per predefined specifications, from various media, including, but not limited to, database tables and/or flat files. The program code obtains reference data defined in a secure solutioning blueprint and applies, to these data, an algorithm-based solutioning process, to identify optimal solution components based on system requirements (included those ingested by the program code). In designing a system to meet cybersecurity requirements, the program code can generate a list of offerings, products, and/or services that satisfy solution requirements for the deployment on a specific technology platform. In some examples, the program code performs continuous maintenance of the offerings, products, and services inventory. Thus, the recommendations integrated into the design by the program can improve over time and stay current. In some examples, the program code persists a solution (e.g., design) which the program code can modify instantly and/or in real-time when the program code determines that there is a change that impacts the viability of the design, including but not limited to, a change in products and/or in a technology provider. The program code can automatically adapt or change the design to compare cost of a deployed solution on different technology platforms. In some examples, the program code can instantly and/or continuously optimize the solution design when there are changes to requirements and/or security controls. For example, the program code can optimize the solution and continuously adapt the solution to ensure it is optimized by re-applying the machine learning techniques described herein, including, in some examples, an AI/ML engine, which the program code can train and continuously re-train.

Certain of the examples herein comprise program code that, when executed by one or more processors, facilitates an end-to-end the process of designing comprehensive IT solutions in compliance with predefined sets of security requirements or any other security and/or compliance standards (e.g., Zero Trust security) has been provided as an example. The program code in these examples outputs a design of a system that includes a set of architecture components, each aligned to the specifications, including, in some examples, Zero Trust specifications. Hence, the program code executing on one or more processors defines a foundation for an AI driven system design by applying design pattern detection techniques.

Various security standards are developed that define compliance requirements for IT systems. IT systems which are designed are often required to comply with these standards. These standard can be complex and can change often and operating an IT infrastructure in compliance with these standards, including actively enforcing these standards at processing and at runtime, is a challenge, especially when systems become more complex and are shared by multiple users. The examples herein include a computer system, computer program product, and computer-implemented method where program code executing on one or more processors automatically designs systems and enforces compliance within the system, of cybersecurity standards, including but not limited to Zero Trust.

A challenge in designing, implementing, and enforcing a cybersecurity system (that complies with a standard), as is accomplished by the examples herein, is that cybersecurity implementations include risks of leaving gaps based on an insufficient level of understanding of key operational aspects. Certain existing (yet manual) approaches address security gaps in system design by utilizing digital transformation initiatives that can involve major reengineering efforts and extensive testing of system components and technologies to be implemented. The Zero Trust security model has been promoted as an effective approach toward mitigating well-know security threats and continuously emerging sophisticated malicious attacks However, implementing Zero Trust can be tedious and time-consuming and the resultant implementation can be lacking in that it does not include a comprehensive and complete understanding of security implementations in the design due to a lack of an effective and systematic design methodology.

The examples herein fill the existing gaps in cybersecurity system design, implementation, and/or enforcement by utilizing a combination of AI and design references to determine an optional design for a given requirement set (which can be Zero Trust). As will be described in greater detail herein, program code executing on one or more processors in certain examples herein obtains a predefined set of input parameters and references and based on the input, generates a complete system design. The program code generating the complete design provides significantly more than existing approaches at least because this aspect replaces manual design work that otherwise is typically performed by a team of SMEs, such as business analysts, architects, technologists, and security. The examples herein are inextricably tied to computing and directed to a practical application at least because the utilization of AI described herein advances an AI solution such that it can aid in producing an end-to-end system design. The aspects described herein enable program code applying the AI-based solution to establish a foundation for the future understating of the best design practices which benefits future AI inclusions in systems automation the design processes.

The examples herein are inextricably tied to computing at least because the method, computer program products, and computer systems described herein comprise program code executing on one or more processors that automates design of IT systems which are subject to security standards. In some examples, the program code implements and enforces these designs. One example of a specification from which program code herein can generate IT systems in a Zero Trust cybersecurity specification. In examples herein, program code executing on one or more processors model a system by, among other aspects, collecting and analyzing data from endpoint computer devices, including but not limited to preformatted data sets, and applies dynamic reference artifacts to produce a system design in compliance with an in-scope security standard (e.g., Zero Trust). As will be discussed in greater detail herein, the examples described herein are directed to a practical application because in addition to generating a system design, the example herein are flexible to address a known issues in computing, which is that, according to National Institute of Standards and Technology (NIST), there is no agreement regarding cybersecurity including the definition of cybersecurity itself. Thus, the flexibility of the examples herein enables the program code to design systems which are in compliance with various standards, including but not limited, the Zero Trust cybersecurity specification. Designing a system with this flexibility is a known issue because it is both difficult and challenging (e.g., there is a low level of confidence) in current design approaches regarding design effectiveness and constraints. However, the examples herein, despite these challenges, can automatically generate an optimized design to improve the quality or/or reduce the overall cost of a system with cybersecurity accounted for in the design.

The examples herein provide significantly more than existing approaches to designing systems in compliance with cybersecurity standards. There are various known issues with designing standard-compliant systems, none of which is an issue when utilizing the examples described herein. The examples herein comprise a comprehensive method that can be effectively implemented in an automated AI-driven system design. Implementation of the examples herein addresses and remedies previously inconsistent interpretations of requirements to satisfy security and compliance regulations. Additionally, because the examples herein are automated and utilize machine learning, this approach eliminates costly and mostly manual efforts to translate customers'system requirements into a standard-compliant system design. The examples herein are flexible across various systems and can be used to design and implement cybersecurity measures to work cooperatively with a cloud solutioning process. Hence, in designing an infrastructure, unlike in present approaches, program code in the examples herein can recommend and/or select products, technologies and services for an end-to-end cloud solution design and meets Zero Trust cybersecurity specifications. The examples herein are automated and provide a low-cost solution, including from a processing cost standpoint, while existing approaches are mostly manual resulting in elongated design cycles, thus commonly are of a higher solution cost. Thus, the examples herein provide an optimization to the design and implementation process.

As will be described in greater detail herein, in some examples, program code executing on one or more processors applies generative AI to generate data (e.g., a summary of information) originating from various sources to be included in a cybersecurity design. The data processed by the AI (including machine learning algorithms), can include, but is not limited to, requirements documents, requests for proposal, compliance and regulatory documents, a system user's cybersecurity compliance standards and guidelines, supplemental best practices and recommendations, etc. Program code applying generative AI can format output data comprising a common control set. This control set can be utilized as machine language in an automated design process. By formatting the input data for ingestion by the generative AU, and utilizing a solution reference blueprint, program code comprising the examples herein can ensure that the design outcome meets the expected cybersecurity specifications, which can include but are not limited to, Zero Trust specifications. This solution blueprint can comprise an aggregation of solution architecture domains and security controls and that is a generic representation of a complete IT system. This system can include software and/or a hardware infrastructure (e.g., which hosts the software). Domains can include, but are not limited to, governance, data, application, IAM, infrastructure, threat, computer, storage, network, resiliency, service management, and services.

Certain examples herein are also inextricably tied to computing based on utilizing machine learning models as part of the paradigm. In these examples, the program code develops and trains machine learning models, including with underlying recurrent neural networks (RNNs) and/or convolutional neural network (CNNs), to generate infrastructure designs and design paradigms, which can be implemented in computing systems (including in enterprise computing systems). The program code continuously updates and refines the model to improve accuracy and efficiency. As will be discussed herein, the program code generates, refines, and continuously tunes machine learning algorithms which are utilized by the program code to generate (and re-generate) infrastructure designs which comply with specifications, including but not limited to, cybersecurity standards.

Neural networks, which are utilized in certain of the examples herein, refer to a biologically inspired programming paradigm which enables a computer to learn from data from disparate data sources. This learning is referred to as deep learning, which is a set of techniques for learning in neural networks. Neural networks, including modular neural networks, are capable of pattern recognition with speed, accuracy, and efficiency, in situations where data sets are multiple and expansive, including across a distributed network of the technical environment. Modern neural networks are non-linear statistical data modeling tools. They are usually used to model complex relationships between inputs and outputs or to identify patterns in data (i.e., neural networks are non-linear statistical data modeling or decision-making tools). In general, program code utilizing neural networks can model complex relationships between inputs and outputs and identify patterns in data. Because of the speed and efficiency of neural networks, especially when parsing multiple complex data sets, neural networks and deep learning provide solutions to many problems in image recognition, speech recognition, and natural language processing. Neural networks can model complex relationships between inputs and outputs to identify patterns in data, including in images, for classification. For this reason, machine learning models in the examples herein can utilize neural networks to generate a technical infrastructure design for a computing environment which the program code can, in some examples, implement and enforce.

In certain embodiments of the present invention the program code utilizes a CNN. CNNs are so named because they utilize convolutional layers that apply a convolution operation (a mathematical operation on two functions to produce a third function that expresses how the shape of one is modified by the other) to the input, passing the result to the next layer. The convolution emulates the response of an individual neuron to visual stimuli. Each convolutional neuron processes data only for its receptive field. It is generally not practical to utilize general (i.e., fully connected feedforward) neural networks to process data rich objects, as very high number of neurons would be necessary, due to the very large input sizes associated with larger files. Utilizing a CNN addresses this issue as it reduces the number of free parameters, allowing the network to be deeper with fewer parameters, as regardless of the file size, the CNN can utilize a consistent number of learnable parameters because CNNs fine-tune large amounts of parameters and massive pre-labeled datasets to support a learning process. CNNs resolve the vanishing or exploding gradients problem in training traditional multi-layer neural networks, with many layers, by using backpropagation. Thus, CNNs can be utilized in large-scale recognition systems, giving state-of-the-art results in segmentation, object detection, and object retrieval. Semantic recognition is an example of large-scale recognition in which a CNN can be utilized by the program code.

In certain embodiments of the present invention the program code utilizes an RNN. An RNN is a class of NN where connections between units form a directed cycle to exhibit dynamic temporal behavior. Unlike feedforward NNs, RNNs can use their internal memory to process arbitrary sequences of inputs. For this reason, current applications of RNNs include unsegmented data recognition, connected handwriting recognition, and speech recognition. Given that LLMs can receive speech as well as natural language in other formats (e.g., text), including via a chatbot, an RNN can be utilized in various examples herein. RNNs can also be utilized to analyze the input in these examples, which can have a specialized language or pattern.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random-access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

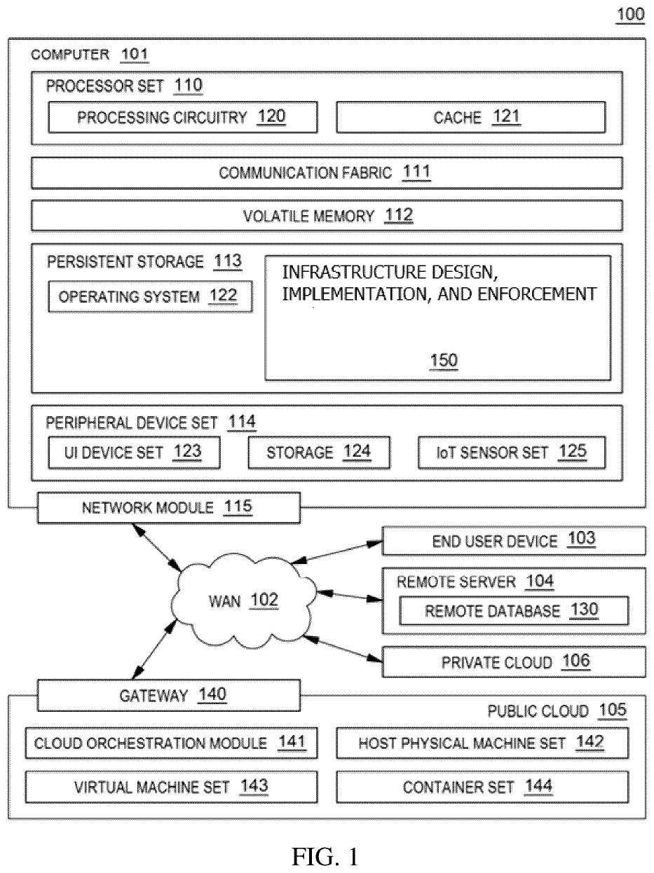

One example of a computing environment to perform, incorporate and/or use one or more aspects of the present disclosure is described with reference to FIG. 1. In one example, a computing environment 100 contains an example of an environment for the execution of at least some of the computer code involved in performing the inventive methods, such as a code block for infrastructure design, implementation, and enforcement 150. In addition to block 150, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 150, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

Computer 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

Processor set 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 150 in persistent storage 113.

Communication fabric 111 is the signal conduction path that allows the various components of computer 101 to communicate with each other. Typically, this fabric is made of switches and electrically conductive paths, such as the switches and electrically conductive paths that make up buses, bridges, physical input/output ports and the like. Other types of signal communication paths may be used, such as fiber optic communication paths and/or wireless communication paths.

Volatile memory 112 is any type of volatile memory now known or to be developed in the future. Examples include dynamic type random access memory (RAM) or static type RAM. Typically, the volatile memory is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

Persistent storage 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid-state storage devices. Operating system 122 may take several forms, such as various known proprietary operating systems or open-source Portable Operating System Interface-type operating systems that employ a kernel. The code included in block 150 typically includes at least some of the computer code involved in performing the inventive methods.

Peripheral device set 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made though local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

Network module 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

End user device (EUD) 103 is any computer system that is used and controlled by an end user (for example, a customer of an enterprise that operates computer 101) and may take any of the forms discussed above in connection with computer 101. EUD 103 typically receives helpful and useful data from the operations of computer 101. For example, in a hypothetical case where computer 101 is designed to provide a recommendation and/or review to an end user, this recommendation would typically be communicated from network module 115 of computer 101 through WAN 102 to EUD 103. In this way, EUD 103 can display, or otherwise present, the recommendation and/or review to an end user. In some embodiments, EUD 103 may be a client device, such as thin client, heavy client, mainframe computer, desktop computer and so on.

Remote server 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation and/or review based on historical data, then this historical data may be provided to computer 101 from remote database 130 of remote server 104.

Public cloud 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

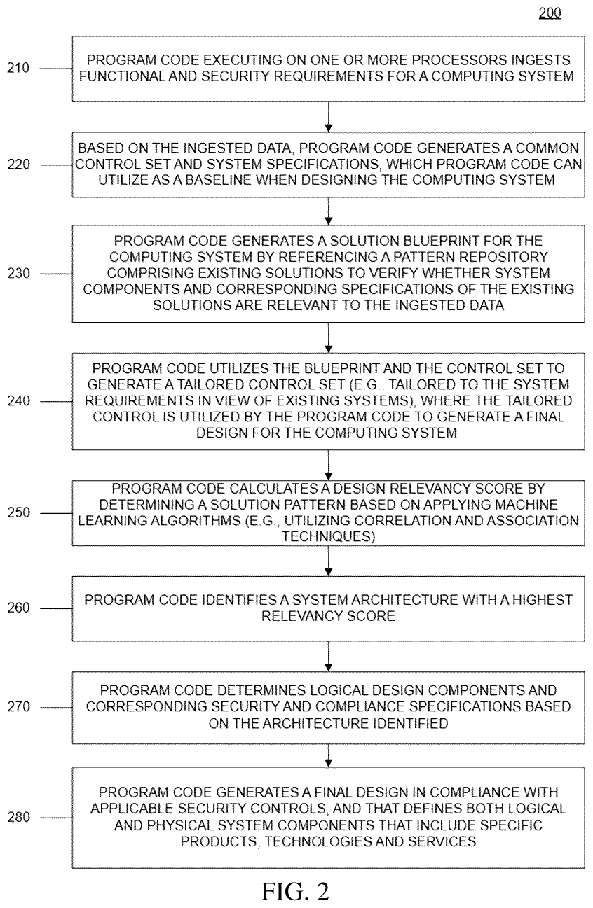

The examples herein include computer-implemented methods, computer program products, and computer systems where program code executing on one or more processors automatically design of IT systems using AI and machine learning in compliance with cybersecurity standards. The program code can also implement the design and enforce the standards, in addition to continuously adapting the design as the optimal solution (e.g., original design) is impacted by internal and/or external changes. FIG. 2 is a workflow 200 that illustrates a general view of various aspects of the examples herein. Certain of the aspects illustrated by FIG. 2 are described in greater detail herein.

Referring to FIG. 2, in some examples herein, program code executing on one or more processors ingests functional and security requirements for a computing system (210). Based on the ingested data, the program code generates a common control set and system specifications, which the program code can utilize as a baseline when designing the computing system (220). Program code generates a solution blueprint for the computing system by referencing a pattern repository comprising existing solutions to verify whether system components and corresponding specifications of the existing solutions are relevant to the ingested data (230). Program code utilizes the blueprint and the control set to generate a tailored control set (e.g., tailored to the system requirements in view of existing systems), where the tailored control is utilized by the program code to generate a final design for the computing system (240). The program code calculates a design relevancy score by determining a solution pattern based on applying machine learning algorithms (e.g., utilizing correlation and association techniques) (250). The program code identifies a system architecture with a highest relevancy score (260). The program code determines logical design components and corresponding security and compliance specifications based on the architecture identified (270). The program code generates a final design in compliance with applicable security controls, and that defines both logical and physical system components that include specific products, technologies and services (280). In some examples, the program code provides the preliminary and target design to an SME for feedback and the program code can implement the feedback.

Throughout the workflow 200 illustrated in FIG. 2, the program code can utilize various AI and machine learning to generate a final design for a computing system. As aforementioned, this design can include both logical and physical system components that include specific products, technologies and services. The program code in the examples herein can utilize a cognitive agent to generate a complete standard-compliant system design, and that can identify products, technologies, and services to be included in the final solution as part of cognitive architecture decisions. The program code can apply an ML engine to identify the products, technologies, and services to be included in the computing system which satisfy security and compliance specifications. The program code can apply an ML engine to optimize a design of a standard-compliant solution to lower its cost or to identify optional components that can be included as part of the solution implementation, or during the system operations.

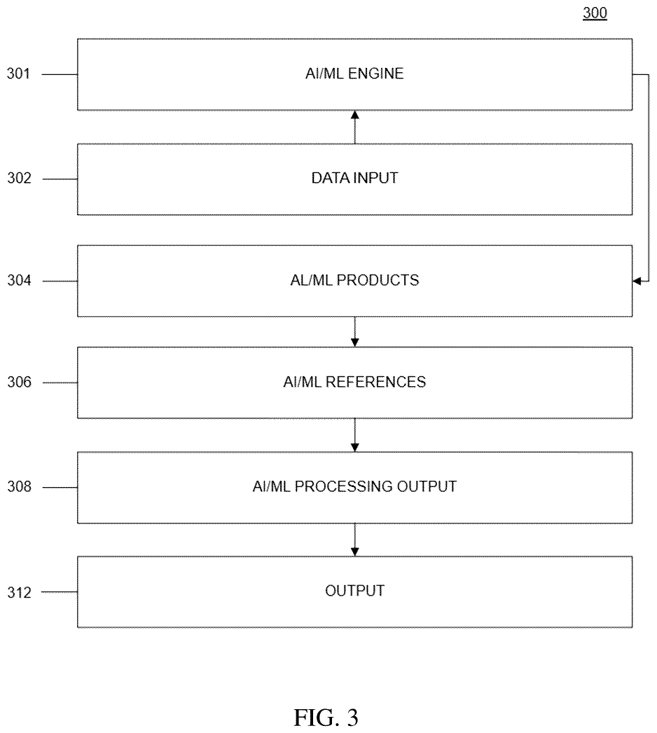

FIG. 3 illustrates aspects of the examples herein as a component diagram 300 comprised of six components. This configuration is provided for illustrative purposes only as a possible configuration for executing various aspects described herein. Each of these components will be described in accordance with aspects also illustrated in FIG. 3. The components include an AI/ML engine 301, data input 302, AI/ML products 304, AI/ML engine 301 references 306, AI/ML processing output 308, and output 312. Each component and its interactions in the context of the examples herein are described below.

As will be described relative to the components 300 of FIG. 3, program code in the examples herein generating a system design results in a comprehensive design that accounts for a totality of the system, including cybersecurity. Typically, a customer provides requirements which are incomplete. Thus, in the examples herein, program code comprising an AI/ML engine 301 performs an assessment of the requirements set defined in an input data set (e.g., data input 302), and it matches the data against existing solution patterns available in a solution pattern repository (e.g., AI/ML products 304) that includes completed designs, and that is continuously evolving with new design references, as they become available. In some examples herein, program code comprising an AI/ML engine 301 produces a requirements specification document and utilizes this document to define architecture components that provided expected system features. The architecture components are technology agnostic as part of the initial design step, thus, the design is portable and it can be deployed on any technology platform pending preferences and other factors, such as cost, for example. Industry standards can include well-defined controls, and if in scope of given design effort, program code can apply the AI/ML engine 301 (when obtaining input) to generate a base control set that includes all controls to be considered by the program code when generating the design (e.g., output).

The components include data input 302, which as aforementioned is ingested by program code executing on one or more processors in the examples herein. These data can be understood as input data for a generative AI or machine learning engine (e.g., comprising one or more machine learning algorithms). In some examples, the program code can process and format these data and in others, the data is provided to the program code in as pre-formatted data sets.

Data input 302 can include, but is not limited to, customer requirements for the target system, industry standards and corresponding controls, and/or security and compliance requirements and compliance controls. Program code in some examples can obtain customer requirements by generating and/or controlling a user interface (UI) to obtain user inputs and/or by automatically ingesting these data from files (e.g., preformatted datasets, text files, unstructured datasets, documents, pdfs, images, specifications, etc.). The program code ingests these data and can convert these data into structured variables and categorical data for use by an AI/ML engine 301 (including one or more algorithms and/or one or more classifiers comprising the engine). The customer requirements can be understood as a set of desirable business functions and features expected from the system to be designed by the program code.

In some examples, the data input 302 can include industry standards and corresponding controls. These can include industry standards that are applicable to the customer's business. For example, depending on the user of the system being designed by the program code, the industry standards could include PCI DPA, HIPAA and/or GDPR. These specifications are provided by the program code to an AI/ML engine 301 which utilizes these standards as controls. When and if these standards change, the AI/ML engine 301 can be re-trained utilizing revised or new standards.

In some examples, the data input 302 can include security and compliance requirements for corresponding controls. This input can include design requirements specified by the SMEs, including those with expertise in security. Program code in some examples can obtain these data by generating and/or controlling a user interface (UI) to obtain user inputs and/or by automatically ingesting these data from files (e.g., preformatted datasets, text files, unstructured datasets, documents, pdfs, images, specifications, etc.). These requirements are relevant to the system design itself and the need to operate and support the system in a secure and a compliant manner.

As illustrated in FIG. 2, program code executing on one or more processors ingests functional and security requirements for a computing system (210). This input data includes the data input 302 in FIG. 3. Program code executing on one or more processors, ingests these data, can process these data, and provides these data to an AI/ML engine 301. Program code comprising the AI/ML engine 301 ingests these data and aggregates information to generate a common control set and system specifications, which the program code can utilize as a baseline when designing the computing system (FIGS. 2, 220). In some examples, the program code can apply generative AI techniques, in order to streamline data processing, including but limited to, document summarization and/or image recognition. In some examples, the program code obtains the data input 302 in certain pre-defined formats (e.g., csv files) and can utilize one or more machine learning algorithms to create, enhance, classify and organize the requirements into the design categories, and/or domains.

Returning to FIG. 3, the components also include AI/ML engine products 304. Program code comprising an AI/ML engine 301 generates AI/ML engine products 304 including a feature store and a base control set for use in the design generated by the program code.

The program code comprising the AI/ML engine 301 persists system requirements (e.g., features) to generate a feature store, one of the AI/ML engine products 304. The program code of the AI/ML engine 301 (comprised, e.g., of self-learning algorithms) identifies and maps variables to generate base controls as well as tailored or custom controls that are utilized by the program code in generating a system design, including but not limited to, a Zero Trust compliant design. In examples where the program code generates a Zero Trust compliant system design, the Zero Trust design generated by the program code includes solutioning domains and corresponding system components with controls at both a logical (architecture) and a physical (implementation) component level.

Depending on the standard, various requirements can be pre-defined and are utilized by the program code. Returning to the non-limiting Zero Trust example, this Zero-Trust ecosystem includes internal, compliance, and/or external variables. The large (and growing) number of variables associated with this standard present a challenge in utilizing existing approaches to generate recommendations and redundant controls. In the examples herein, program code comprising the AI/ML engine 301 weighs features and requirements to identify influential system features and to generate the most relevant solution patterns.

In the examples herein, program code comprising the AI/ML engine 301 generates a base control set (one of the AI/ML engine products 304). This base control set is an initial set of security and compliance controls generated by the AI/ML engine 301 based in ingesting and processing the data input 302. Program code of the AI/ML engine 301 can enhance the ingested data to fill any gaps the program code identifies in the requirements. To fill these gaps, in some examples, program code comprising the AI/ML engine 301 accesses a reference solution pattern repository and solutioning blueprint to identify and close the design gaps based on the best practices identified in a relevant system, for example, a system utilized to provide a similar solution and/or a system that is utilized in a similar industry as the system the program code will design. Thus, the program code can generate a tailored control set which includes a final set of controls to be included in a compliant design (generated by the program code).

In the examples herein, the aforementioned base control set includes the initial set of security controls that define a component level specification, including but not limited to, Zero Trust specifications. In some examples, the AI/ML engine 301 comprises a classifier. A classifier can be comprised of various cognitive algorithms, artificial intelligence (AI) instruction sets, and/or machine learning algorithms. Classifiers can include, but are not limited to, deep learning models (e.g., neural networks having many layers) and random forests models. In certain of the examples herein, the classifier comprises a random forests model. Generally, classifiers classify items (data, metadata, objects, etc.) into groups, based on relationships between data elements in the metadata from the records. In some embodiments of the present invention, the program code can utilize the frequency of occurrences of features in mutual information in the input data to identify and filter out false positives. In general, program code utilizes a classifier to create a boundary between data of a first quality data of a second quality. As a classifier is continuously utilized, its accuracy can increase as testing the classifier tunes its accuracy. When training a classifier, in some examples, program code feeds pre-existing specifications and input data describing elements of a design of a computing system (e.g., metadata and/or data) into the one or more cognitive analysis algorithms that are being trained. The program code trains the classifier to classify records based on the presence or absence of a given condition, which is known before the tuning. The presence or absence of the condition is not noted explicitly in the records of the data set. When classifying elements of input data to generate a base control set, utilizing the classifier, the program code can indicate a probability of a given aspect for inclusion in the design or control set with a rating on a scale, for example, between 0 and 1, where 1 would indicate a definitive presence. The classifications need not be binary and can also be values on an established scale. In certain examples herein, program code comprising the classifier of the AI/ML engine 301 runs a random forest model with an initial system feature list for relevance and ranking to generate a common security control set.

By generating the base set and the feature store (e.g., the AI/ML engine products 304), program code comprising the AI/ML engine 301 establishes solution requirement specifications that become the base for the design of the system. In some examples, the program code generates a design comprising a collection of logical architecture components that are technology-agnostic and each component satisfying the applicable controls identified in the base security control set.

Returning to FIG. 3, program code executing on one or more processors in certain of the examples herein generates, stores, and references, certain data and utilizes these data in generating a final design. FIG. 3 depicts these data as AI/ML engine references 306. The references 306 can comprise, in some examples herein, a reference solution pattern library, a solutioning reference blueprint, and specifications that correspond to products, technologies, and/or standards (e.g., Zero Trust specification).

The reference solution pattern library of the AI/ML engine references 306 is a repository used by program code comprising the AI/ML engine 301 to store final solution design patterns previously produced (including by the program code in the examples herein) or vendor best practices-based blueprints for different requirements set and domains. The data in the repository, as written and retained by the program code, can be structured as domains, components, controls, products and/or solution patterns with a pattern identifier. Data utilized to train the machine learning algorithms that comprise the AI/ML engine 301, including but not limited to historical solution patterns, can be stored by the program code in a pattern library (e.g., a file and/or database) as reference data. Program code in the examples herein can continuously update the historical data to include any new and completed designs and the program code comprising the AI/ML engine 301 can continuously access these data to continuously train (e.g., tune) the machine learning algorithms.

The solutioning reference blueprint of the AI/ML engine references 306 is a reference (e.g., file, data store, etc.) that can include solutioning domains, security controls and/or system features that comprise best solutioning and security practices in the presence or absence of certain features (e.g., in certain domains, architecture, environments, etc.). Program code comprising the AI/ML engine 301 can identify gaps in input data (ingested by the program code) and utilize the data in the blueprint to fill gaps in system specifications and features and security controls. In contrast to the pattern library, which is updated continuously by the program code, the blueprint is a relatively static reference. However, it can be updated by the program code to include new domains, features and/or security controls to reflect emerging solutioning practices or security and compliance requirements. Thus, program code in the examples herein will not generate a design with a deficit based on missing data.

The specifications that correspond to products, technologies, and/or standards (e.g., Zero Trust specification) of the AI/ML engine references 306 include as inventory (e.g., file, data store, etc.) of vendor-specific products and technologies, which can include product technical and security specifications including vendor recommended (e.g., Zero Trust) configuration and security. Program code comprising the AI/ML engine 301 continuously updates and refreshes these specifications to include new offerings. In the examples herein, program code comprising the AI/ML engine 301 can utilize an offering reference to finalize a solution design by including in this design logical (architecture) components and/or physical (products and product specifications).

Referring to FIG. 3, AI/ML processing output 308, which is a logical design for a computing system, generated by the program code, can include both: 1) a tailored control set; 2) a solution architecture and components specifications. The former includes a recommended set of security controls based on the established best design practices that program code applying the machine learning algorithms (of the AI/ML engine) identifies and provides to close the gaps in requirements. The tailored control set is generated by the program code by optimizing the base control set, which was generated by the program code earlier in the process. Program code of the AI/ML engine performs this optimization using a solutioning blueprint and references in the solution pattern repository. In some examples herein, the tailored control set can include an initial set of security controls that define the component level specifications, including but not limited to, Zero Trust specifications. Program code comprising a classifier in the AI/ML engine can run a Random Forest model with a finalized feature list to generate the tailored control set. Machine learning algorithms comprising the AI/ML engine can task input from solution requirements specifications generated by the program code and incorporates recommendations from the existing solution pattern references to produce a final solution design component list. This design can comprise components that meet the specifications defined in the tailored control set.

The latter AI/ML processing output 308 is a solution architecture and components specifications, which is an initial set of system architecture components that are logical design entities generated by program code of the AI/ML engine. The solution architecture and components specifications fulfill system features described in the system requirements. In some examples herein, architecture components are technology-agnostic and are defined by program code of the AI/ML Engine to comply with Zero Trust specifications. An initial set of architecture components generated by the program code are optimized by the AI/ML engine to ensure the completeness of the logical system design. In some examples, program code of the AI/ML engine identifies technologies (physical components) in the existing solution patterns, including but not limited those that are vendor or service provider specific, to meet a users'preferences or recommendations.

Output 312 generated by the examples herein is the design itself. Components of this design can include: 1) solution components; and 2) products, technologies and corresponding specifications. The solution components generated by the program code can include a set of logical architecture components that constitute a complete and final system design meeting all requirements, which can include customer requirements and specifications (e.g., Zero Trust specifications) for each component identified. In some examples, the program code generates the solution components to include component details which the program code saves in a database or file in a predefined format. In some examples, a component of the solution is a user authentication system that performs a role base authentication (RBAC) or a multifactor authentication (e.g., in compliance with a standard).

In the examples herein, program code executing on one or more processors, can generate products, technologies, and corresponding specifications as output 312. The program code generating this output 312 can be program code of at AI/ML engine 301. In some examples, the program code finalizes the design by providing this aspect in part by obtaining and/or weighing pending customer preferences for specific vendor products or technologies. The program code can identify suitable offerings that fulfill the deployment needs of the logical components identified.

As illustrated in FIG. 3, the AI/ML engine 301 plays a central role in some examples herein. The program code of the AI/ML engine 301 is used at different points in the process described in FIG. 2 to provide recommendations (e.g., output 312) based on input data 302 as well as to classify data. Thus, two examples of utility provided by the AI/ML engine 301 are as a recommender and as a classifier. These aspects have been discussed earlier but are reviewed in additional detail.

Program code comprising the AI/ML engine 301 identifies the most relevant features for various frameworks (e.g., a Zero Trust IT solution) from a wide spectrum of variables the program code generates from requirement data. Program code comprising the AI/ML engine 301 data input 302, optimizes the design by validating it against best design practices documented in a reference solution pattern library and a solutioning blueprint, and generates a final design that includes both logical and physical components. The final design fulfills system requirements and meets compliance requirements (e.g., a Zero Trust specification).

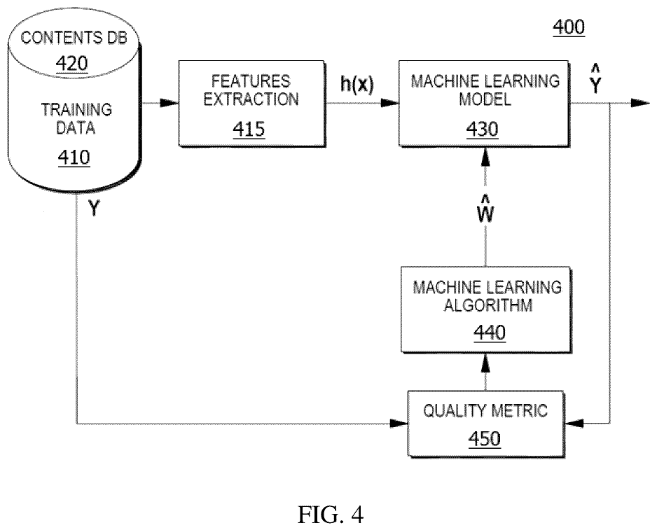

The classifier of the AI/ML engine 301 determines the most relevant features to generate a set of controls based on relevance and rank in the context of the requirements. This set of control can be utilized by the program code (e.g., as a base control set) to generate the tailored control set. The classifier can apply various feature selection techniques to convert variables from requirements into features to derive the control set based on the relevance and ranking. FIG. 4 depicts an example of a classifier 400 which is included in the AI/ML engine in certain of the examples herein. ML solves problems that are not solved with numerical means alone. In this ML-based example, program code extracts various attributes (415) from the data input 410. The program code can utilize these attributes to develop a predictor function, h(x), also referred to as a hypothesis, which the program code utilizes as a machine learning model 430, in this case, to predict the most relevant features from the data input 302. The program code can identify various attributes and/or parameters in data input 203, having been trained on ML training data 410, which can be stored in one or more contents database 420, the program code can utilize various techniques to identify the most relevant attributes in the data input 302. Embodiments of the present invention utilize varying techniques to select attributes (elements, patterns, features, components, etc.), including but not limited to, diffusion mapping, principal component analysis, recursive feature elimination (a brute force approach to selecting attributes), and/or a Random Forest, to select the attributes related to various parts of the data input 302. The program code can utilize a machine learning algorithm 440 to train the machine learning model 430 (e.g., the algorithms utilized by the program code), including providing weights for the conclusions, so that the program code can train the predictor functions that comprise the machine learning model 430 to generate and/or implement recommended changes in the processes. The conclusions can also be evaluated by a quality metric 450. By providing a diverse set of ML training data 410 from multiple process runs, the program code trains the machine learning model 430 to identify and weight various attributes (e.g., features, patterns, components) to enable the program code to recommend and/or automatically implement aspects in a system design.

Returning to FIG. 3, program code of the recommender of the AI/ML engine 301 can match an existing solution pattern based on the features defined in system requirements. Program code comprising the recommender can ingest, parse, and cognitively analyze a base control set (generated by the program code) to and apply association and correlation techniques to remove redundant controls and recommend the most relevant solution patterns (e.g., with relevancy scores). In some examples, the program code comprising the recommender can provide a scoring approach for a nearest match depending on availability of a solution pattern for a particular component.

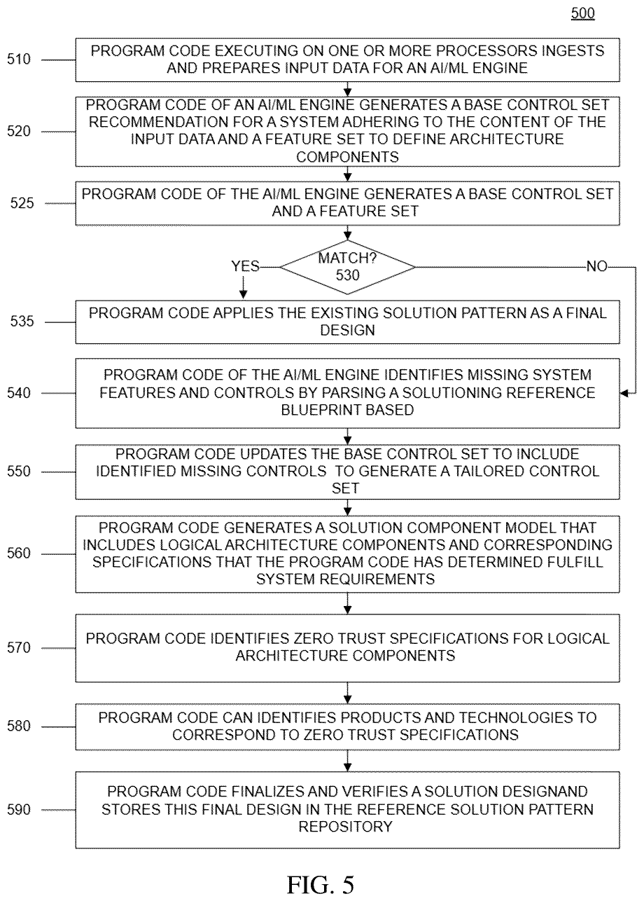

FIG. 5 is a workflow 500 that illustrates various aspects of some examples herein and includes mentions of the components 300 of FIG. 3. As illustrated in FIG. 5, program code executing on one or more processors ingests and prepares input data for an AI/ML engine (510). The data can include customer requirements for a target system (e.g., business requirements, system features, security and compliance), industry standards (e.g., PCI, HIPAA, GDPR, etc.), security and compliance requirements (e.g., requirements defined by a security organization, common best practices for a target system, etc.). In some examples, the program code can apply a generative AI to summarize or otherwise format these data from varying sources. Thus, the program code can process these data by applying various generative AI techniques. The data can include requirements as well as standards and the program code can format these data into input data sets for one or more AI/ML algorithms.

Upon obtaining the input data, program code of an AI/ML engine (e.g., one or more trained algorithms) can generate a base control set recommendation for a system adhering to the content of the input data and a feature set to define architecture components (520). The program code applies machine learning (e.g., a classier) to identify pertinent data and weight requirements (e.g., confirming the capabilities relevance levels). The program code of the AI/ML engine can also identify existing solution patterns that match system requirements. The base control set are controls generated by the AI/ML engines that provide the input to defining the specifications (e.g., Zero Trust specifications). The feature set is a set of system requirements based on the input data and used to define architecture components. Requirements specifications and a base control set can be regarded as two separate components that are generated by the program code.

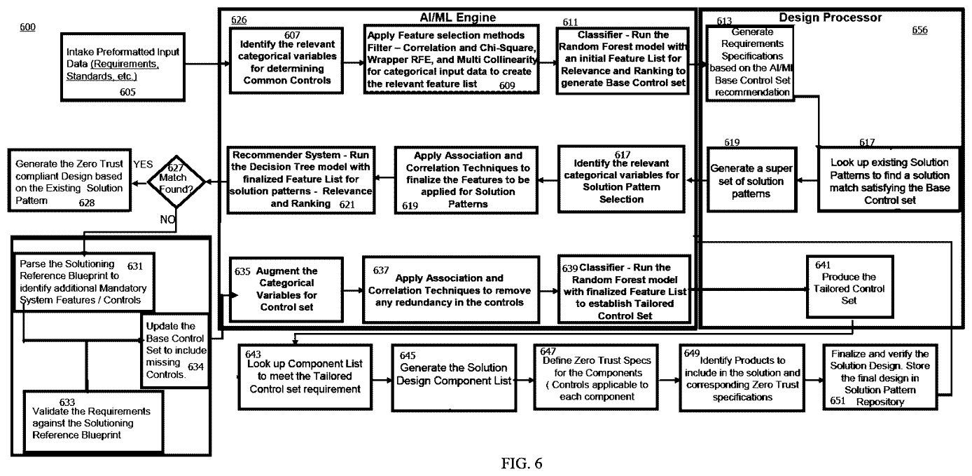

In different examples the program code of the AI/ML engine can process input data in various manners. For example, the program code can obtain input data as a result of responses from a questionnaire or analyst response based on the requirements provided by a client. The input data can comprise a set of categorical variables like ISO27001 Compliance, AES256/128, GDPR Compliance required, HIPAA, Customer Data Protection Policy, or other network, application and database security measures, Single Sign On requirements, auditability requirements etc. The program code ultimately determines how to implement controls to satisfy these requirements at various component levels in the system architecture. In some examples, requirements will have overlap as certain requirements can be addressed by common solutions. As will be illustrated herein (e.g., FIG. 6) when program code of the AI/ML engine processes the input data, it can remove redundant variables and automatically select a subset of most appropriate and relevant features the program can use in model building and in executing the model. The program code can select features either by including the important features or excluding the irrelevant features in the dataset without changing the features. In some examples, the program code runs a random forest model to finalize the common controls based on the ranking and relevance by domain and components. Thus, the program code (applying AI/ML techniques) can generate common controls to address requirements by domain and/or by component. Because the set of variables can be large, the program code in the examples herein can utilize a feature store (e.g., a reference solution pattern repository) to help capture features associated with each requirement and facilitate training and run time for the models.

Returning to FIG. 5, after the program code of the AI/ML engine generates the base control set and the feature set (525), and the program code determines if these products of the AI/ML engine match any solution patterns in an existing reference solution pattern repository (530). This reference solution pattern repository can be updated continuously as the process continues to run, thus increasing the likelihood of a match at each iteration. If the program code can match the base control set and the feature set to a solution pattern, the program code applies the existing solution pattern as a final design (535). Thus. The program code can generate a Zero Trust compliant design based on an existing solution pattern (from the repository). However, if there is no match, the program code continues to generate a design. For example, the program code can generate a final security compliant design (e.g., a Zero Trust compliant design) based on the existing solution patterns available in the reference solution pattern repository, if an optimal match found in the that fulfills the system requirements. In some examples, the program code can match requirements to existing Zero Trust solution patterns and this can create solution patterns by mapping components, base controls, and domains to the reference solution pattern repository. In this matching, the program code can utilize a common control set to extract pre-defined solution patterns based on a threshold match for domains, base control set, and associated components (e.g., 75%). Thus, the program code need not be a 100% match provided that an existing solution in the repository meets a predetermined threshold.

As illustrated in FIG. 6, AI/ML techniques can be utilized by the program code to determine whether there is a match. The program code can generate (and continuously update/train) a recommender system to identify a most suitable solution pattern (e.g., in the repository) based on a highest relevance ranking. The program code can then utilize this solution provided that the highest relevance ranking meets a predetermined threshold. The threshold can be configured in advance and in one example, can be configured such that controls are met for a minimum threshold of 75%.

When the program code cannot match the base control set and the feature set to a solution pattern (e.g., a threshold is not met), the program code utilizes the solution pattern repository as well as a solutioning reference blueprint (which can include solutioning and security domains) to fill gaps. The program code of the AI/ML engine identifies missing system features and controls by parsing a solutioning reference blueprint (e.g., the program code performs a solution blueprint analysis) (540). During this parsing, in some examples, the program code can identify additional mandatory system features and controls (that are not resident in the reference solution repository). The program code updates the base control set to include these missing controls (e.g., based on the program code performing an analysis of the solution blueprint) to generate a tailored control set (550). The output from the program code performing this processing, the tailored control set, includes a complete set of controls which the program code can document in a final design. Thus, the program code initially generates (by applying AI/ML algorithms and ingesting data), a base control set and solution requirements specifications but now generates a tailored control set.

In some examples, when the program code determines that no matches are found for the solution pattern, the program code can augment the variables from the Blueprints to add any new features and check any discarded features for the impact. The program code can run a classifier to generate a tailored control set. The program code can run a recommender to identify the relevant components for a solution pattern. The program code can identify matching solution patterns with different thresholds to combine, if possible, to create a new solution pattern or the program code can generate a new solution pattern based on the tailored control set.

Returning to FIG. 5, the program code generates a solution component model (which can also be referred to as a solution design component model) that includes logical architecture components and corresponding specifications that the program code has determined fulfill system requirements (560). For example, the program code can match the components to products. The program code also identifies Zero Trust specifications for logical architecture components (570). These specifications are technology-agnostic and can be utilized as part of vendor-specific products selection to ensure and/or maintain consistency between logical and physical system parameters. The program code can identify products and technologies which are vendor-specific and correspond to Zero Trust specifications (which the program code includes in a completed solution design (580). In order to identify specific products and technologies the program code can access one or more databases that include various products (including cloud products) which can address the identified specifications. The program code can then finalize and verify the solution design which includes storing this final design in the reference solution pattern repository (590).

Although various implementations of the aspects discussed herein can be utilized, in some examples, certain functionalities can be viewed as separate modules, as a non-limiting example and just for ease of understanding. Certain of the functionalities can be understood as an interplay between program code comprising and/or applying an AI/ML engine and program code comprising a design processor. FIG. 6 illustrates a workflow 600 that includes program code comprising and applying an AI/ML engine 626 and program code comprising a design processor 656. In this example, as in FIG. 5, program code obtains pre-formatted input data (e.g., requirements, standards, etc.) (605) and the program code comprising an AI/ML engine 626 obtains these data and identifies relevant categorical variables to determine common controls (607). The program code can apply feature selection methods, including but not limited to, filters, correlation and chi-square, wrapper RFE, and multi collinearity (609). The program code can apply a classifier, for example, to run a random forest model with the initial feature set identified by the program code for relevance and ranking to generate a base control set recommendation (613).

The workflow 600 progresses to program code comprising a design processor 656. The program code comprising the design processors obtains, as output from the AI/ML engine 626, the output of the classifier and the program code generates requirements specifications based on the AI/ML base control set recommendation (615). Thus, the output is a base control set and solution requirement specifications. Referencing the base control set and the solution requirement specifications, the program code accesses a reference solution pattern repository to attempt to identify a solution match that satisfies the base control set (617). The program code then generates a super set of solution patterns (619) and progresses back to the AI/ML engine 626 functionality.

Using the super set of solution patterns, program code comprising the AI/ML engine 626 assists in determining whether a solution from the reference solution pattern repository satisfies the base control set (617) or identifies and fills gaps if there are missing requirements that are not satisfied by the reference solution pattern repository. To this end, the program code of the AI/ML engine 626 identifies relevant categorical variables for solution pattern selection (621). The program code applies association and correlation techniques to finalize features to be applied for solution patterns (623). The program code generates a recommendation for a finalized feature list for solution patterns, for examples, by running a decision tree model and ranking the features by relevance (625).

Once the program code generates a recommendation for a finalized feature list for solution patterns, the program code can (e.g., progress outside of the AI/ML engine module) determine if there is a match in the reference solution pattern repository (627). Based on identifying a match, the program code can generate a Zero Trust compliant design based on an existing solution pattern (in the repository) (628). When there is no match, the program code parses a solutioning reference blueprint to identify addition (e.g., mandatory) system features and/or controls (631). In some examples, the program code validates the requirements against the solutioning reference blueprint. The program code can then update the base control set to include missing controls (633) locating through this analysis.

In some examples, the program code utilizes aspects of the AI/ML engine to assist in generating a tailored control set. To that end, the program code utilizes the AI/ML engine 626 to augment categorical variables for the control set (which includes the vase control set and the missing controls) (635). The program code applies association and correlation techniques to remove any redundancy in the controls (637). The program code applies a classifier to generate a recommendation for a tailored control set (e.g., by running a random forest model with a finalized feature list) (639).

Returning to the design processor 656, program code obtains the recommendation for the tailored control set (output on the AI/ML engine 626) and generates the tailored control set (641). Navigating away from the design processor 656 module (in this example, provided for illustrative purposes only to illustrate a non-limiting configuration), program code looks up a component list to meet the tailored control set (643). Program code generates a solution design component list (645) which can comprise various components. The program code defines Zero Trust specifications for the components (e.g., controls applicable to each component). The program code identifies products to include in the solution and corresponding Zero Trust specifications (647). The program code finalizes and verifies this solution design and stores this final design in the solution pattern repository (updating the solution pattern repository) (651).

This final output from the AI/ML Engine processing concludes the Zero Trust compliant system design that includes logical solution components and an inventory of products and offerings (e.g., vendor-specific) that fulfill system requirements. For each component, both logical (system component) and physical (products, technologies) corresponding Zero Trust specifications are provided by the program code as needed to implement and operate the solution. The program code of the AI/ML Engine performs a design verification against all inputs and reference data and persists a final design in the reference solution pattern repository to be reused in future designs. Examples of Zero Trust component specifications can include but are not limited to the following.
1) Create strong identity verification. Every user is granted the least amount of access possible, on a strict need-to-know basis. Verify explicitly.
2) Use least privileged access.
3) Manage access to devices and networks-Secure all network endpoints all network traffic, and all connections on-premises and remote. Minimize the network access to only those who must be authorized. Deploy network segmentation to minimize impact of security breaches.
4) Establish and configure data access permissions. Classify all enterprise data, secure and provide the least privileged access.
5) Monitor the system infrastructure-limit the access to the infrastructure components by proper configuration and access controls. Deploy means to monitor the infrastructure components and collect evidence and metrics needed to identify and prevent malicious activities.
6) Assume breach.

The examples herein enable traceability between customer requirements, solution components and offerings/products and services that provide for system features and that satisfy all in scope security controls, as identified by AI/ML Engine. Utilizing the example herein enables a compliance verification process that includes tracking of any changes to either design or implementation of the system. As such, the resultant design accounts for customer requirements, which are system features that are designed for and that often include industry standards and corresponding security controls. The program code continuously validates these requirements. The resultant design includes products and services. These are products, technologies, offerings and service capabilities which fulfill specific system features and that can be vendor-specific or provided by specialized service suppliers. The products and services are determined by program code comprising an AI/ML engine by processing through identifying desired products and services in reference tables that are continuously refreshed with the most up to date offerings.

A resultant Zero Trust security compliant design can span various domains, with different requirements for each. For example, in a data domain, security control requirements can include data lifecycle management, data loss prevention, data access, integrity, and monitoring, encryption at rest, encryption in transit, encryption in use, and key and certificate lifecycle management. A design generated by the program code in the examples herein would include components (offerings and/or services) that address each of these requirements. A design can also designate certain requirements mandatory, recommended, and/or optional. In an identity and access management domain, requirements can include identity and lifecycle management, identity governance, access and role management, privileged identity and access management, and secrets management. A design generated by the program code in the examples herein would include components (offerings and/or services) that address each of these requirements and could also designate the priority of the requirements (e.g., mandatory, recommended, or optional).

The examples herein include computer-implemented methods, computer program products, and computing systems for generating a compliant system design for a computing architecture. Some of the examples herein include program code executing on one or more processors ingesting, input data, where the input data comprises requirements and standards for the computing architecture. The program code identifies relevant categorical variables in the input data by applying a machine learning algorithm, where the machine learning algorithm utilizes the relevant categorical variables to determine common controls in the input data. The program code generates, based on the common controls, a recommendation for a base control set for the computing architecture. The program code generates, based on the recommendation, the base control set and solution requirement specifications. The program code determines, based on comparing the solution requirement specifications to a reference solution pattern repository, if a solution in the reference solution pattern repository satisfies the base control.

In some examples, the program code generating the recommendation for the base set further comprises the program code identifying an initial feature set. The program code can also apply a classifier to run a random forest model on the initial feature set to rank features comprising the initial feature set based on relevance, where the recommendation for the base control set comprised the ranked initial features.

In some examples, the program code identifying the initial feature set comprises the program code applying a method selected from the group consisting of: filtering, correlation and chi-square, wrapper recursive feature elimination (RFE), and multi collinearity.

In some examples, the program code determining if the solution in the reference solution pattern repository satisfies the base control set comprises: the program code generating, based on the base control set and the solution requirement specifications, a super set of solution patterns. The program code can also apply a machine learning algorithm to the super set of solution patterns to determine if the solution in the reference solution pattern repository satisfies the base control set. The program code making this determination can include the program code identifying missing requirements in the solution requirement specifications which are not satisfied by the solution. The determination can also include the program code automatically filling, based on elements comprising the solution pattern repository, a portion of the missing requirements. The determination can also include the program code determining if the solution including the automatically filling satisfy a threshold of the super set of solution patterns.

In some examples, the program code determines that the solution in the reference solution pattern repository satisfies the base control set. The program code can make this determination by generating, based on applying a machine learning algorithm, a recommendation for a finalized feature list for solution patterns. Additionally, the program code can utilize the finalized feature list for solution patterns to identify a match in the reference solution pattern repository.

In some examples, based in identifying the match, the program code can generate a Zero Trust compliant design based on an existing solution pattern in the reference solution pattern repository.

In some examples, the program code determines that the solution in the reference solution pattern repository does not satisfy the base control set. To make this determination, the program code can generate, based on applying a machine learning algorithm, a recommendation for a finalized feature list for solution patterns. The program code can also compare the finalized feature list for solution patterns to the reference solution pattern repository.

In some examples, the program code parses a solutioning reference blueprint to identify additional controls. The program code validates the solution requirement specifications against the solutioning reference blueprint. The program code can also update the base control set to include the additional controls. The program code can apply a classifier to generate a recommendation for a tailored control set based on executing a modeling algorithm on the updated base control set and the finalized feature list.

In some examples, the modeling algorithm comprises a random forest model.

In some examples, the program code generates, based on the recommendation for the tailored control set, the tailored control set. The program code compiles a component list to satisfy the tailored control set. The program code defines Zero Trust specifications for components comprising the component list. The program code identifies products to include in a reference solution pattern corresponding to the Zero Trust specifications. The program code generates the reference solution pattern based on the components and the products.

In some examples, the program code updates the reference solution pattern repository with the reference solution pattern.

In some examples, the program code generating the tailored base set further comprises: before applying the classifier to the updated base control set, the program code augments categorical variables for the updated base control set. Additionally, the program code can apply association and correlation techniques to the updated base control set to remove any redundancy.

Various aspects and embodiments are described herein. Further, many variations are possible without departing from a spirit of aspects of the present disclosure. It should be noted that, unless otherwise inconsistent, each aspect or feature described and/or claimed herein, and variants thereof, may be combinable with any other aspect or feature.

The terminology used herein is for the purpose of describing particular embodiments only and is not intended to be limiting. As used herein, the singular forms “a”, “an” and “the” are intended to include the plural forms as well, unless the context clearly indicates otherwise. It will be further understood that the terms “comprises” and/or “comprising”, when used in this specification, specify the presence of stated features, integers, steps, operations, elements, and/or components, but do not preclude the presence or addition of one or more other features, integers, steps, operations, elements, components and/or groups thereof.

The corresponding structures, materials, acts, and equivalents of all means or step plus function elements in the claims below, if any, are intended to include any structure, material, or act for performing the function in combination with other claimed elements as specifically claimed. The description of one or more embodiments has been presented for purposes of illustration and description but is not intended to be exhaustive or limited to in the form disclosed. Many modifications and variations will be apparent to those of ordinary skill in the art. The embodiment was chosen and described to best explain various aspects and the practical application, and to enable others of ordinary skill in the art to understand various embodiments with various modifications as are suited to the particular use contemplated.

What is claimed is:

1. A computer-implemented method for generating a compliant system design for a computing architecture, comprising:
ingesting, by one or more processors, input data, wherein the input data comprises requirements and standards for the computing architecture;
identifying, by the one or more processors, relevant categorical variables in the input data by applying a machine learning algorithm, wherein the machine learning algorithm utilizes the relevant categorical variables to determine common controls in the input data;
generating, by the one or more processors, based on the common controls, a recommendation for a base control set for the computing architecture;
generating, by the one or more processors, based on the recommendation, the base control set and solution requirement specifications; and
determining, by the one or more processors, based on comparing the solution requirement specifications to a reference solution pattern repository, if a solution in the reference solution pattern repository satisfies the base control.

2. The computer-implemented method of claim 1, wherein generating the recommendation for the base set further comprises:
identifying, by the one or more processors, an initial feature set; and
applying, by the one or more processors, a classifier to run a random forest model on the initial feature set to rank features comprising the initial feature set based on relevance, wherein the recommendation for the base control set comprised the ranked initial features.

3. The computer-implemented method of claim 2, wherein identifying the initial feature set comprises applying a method selected from the group consisting of: filtering, correlation and chi-square, wrapper recursive feature elimination (RFE), and multi collinearity.

4. The computer-implemented method of claim 1, wherein determining if the solution in the reference solution pattern repository satisfies the base control set comprises:
generating, by the one or more processors, based on the base control set and the solution requirement specifications, a super set of solution patterns;
applying, by the one or more processors, a machine learning algorithm to the super set of solution patterns to determine if the solution in the reference solution pattern repository satisfies the base control set, wherein the determining comprises:
identifying missing requirements in the solution requirement specifications which are not satisfied by the solution;
automatically filling, by the one or more processors, based on elements comprising the solution pattern repository, a portion of the missing requirements; and
determining if the solution including the automatically filling satisfy a threshold of the super set of solution patterns.

5. The computer-implemented method of claim 1, further comprising:
determining, by the one or more processors, that the solution in the reference solution pattern repository satisfies the base control set, the determining comprising:
generating, by the one or more processors, based on applying a machine learning algorithm, a recommendation for a finalized feature list for solution patterns; and
utilizing, by the one or more processors, the finalized feature list for solution patterns to identify a match in the reference solution pattern repository.

6. The computer-implemented method of claim 5, further comprising:
based in identifying the match, generating, by the one or more processors a Zero Trust compliant design based on an existing solution pattern in the reference solution pattern repository.

7. The computer-implemented method of claim 1, further comprising:
determining, by the one or more processors, that the solution in the reference solution pattern repository does not satisfy the base control set, the determining comprising:
generating, by the one or more processors, based on applying a machine learning algorithm, a recommendation for a finalized feature list for solution patterns; and
comparing, by the one or more processors, the finalized feature list for solution patterns to the reference solution pattern repository.

8. The computer-implemented method of claim 7, further comprising:
parsing, by the one or more processors, a solutioning reference blueprint to identify additional controls;
validating, by the one or more processors, the solution requirement specifications against the solutioning reference blueprint; and
updating, by the one or more processors, the base control set to include the additional controls; and
applying, by the one or more processors, a classifier to generate a recommendation for a tailored control set based on executing a modeling algorithm on the updated base control set and the finalized feature list.

9. The computer-implemented method of claim 8, wherein the modeling algorithm comprises a random forest model.

10. The computer-implemented method of claim 8, further comprising:
generating, by the one or more processors, based on the recommendation for the tailored control set, the tailored control set;
compiling, by the one or more processors, a component list to satisfy the tailored control set;
defining, by the one or more processors, Zero Trust specifications for components comprising the component list;
identifying, by the one or more processors, products to include in a reference solution pattern corresponding to the Zero Trust specifications; and
generating, by the one or more processors, the reference solution pattern based on the components and the products.

11. The computer-implemented method of claim 10, further comprising:
updating, by the one or more processors, the reference solution pattern repository with the reference solution pattern.

12. The computer-implemented method of claim 10, wherein generating the tailored base set further comprises:
before applying the classifier to the updated base control set, augmenting, by the one or more processors, categorical variables for the updated base control set; and
applying, by the one or more processors, association and correlation techniques to the updated base control set to remove any redundancy.

13. A computer system for generating a compliant system design for a computing architecture, comprising:
a memory; and
one or more processors in communication with the memory, wherein the computer system is configured to perform a method, said method comprising:
ingesting, by the one or more processors, input data, wherein the input data comprises requirements and standards for the computing architecture;
identifying, by the one or more processors, relevant categorical variables in the input data by applying a machine learning algorithm, wherein the machine learning algorithm utilizes the relevant categorical variables to determine common controls in the input data;
generating, by the one or more processors, based on the common controls, a recommendation for a base control set for the computing architecture;
generating, by the one or more processors, based on the recommendation, the base control set and solution requirement specifications; and
determining, by the one or more processors, based on comparing the solution requirement specifications to a reference solution pattern repository, if a solution in the reference solution pattern repository satisfies the base control.

14. The computer system of claim 13, wherein generating the recommendation for the base set further comprises:
identifying, by the one or more processors, an initial feature set; and
applying, by the one or more processors, a classifier to run a random forest model on the initial feature set to rank features comprising the initial feature set based on relevance, wherein the recommendation for the base control set comprised the ranked initial features.

15. The computer system of claim 14, wherein identifying the initial feature set comprises applying a method selected from the group consisting of: filtering, correlation and chi-square, wrapper recursive feature elimination (RFE), and multi collinearity.

16. The computer system of claim 13, wherein determining if the solution in the reference solution pattern repository satisfies the base control set comprises:
generating, by the one or more processors, based on the base control set and the solution requirement specifications, a super set of solution patterns;
applying, by the one or more processors, a machine learning algorithm to the super set of solution patterns to determine if the solution in the reference solution pattern repository satisfies the base control set, wherein the determining comprises:
identifying missing requirements in the solution requirement specifications which are not satisfied by the solution;
automatically filling, by the one or more processors, based on elements comprising the solution pattern repository, a portion of the missing requirements; and
determining if the solution including the automatically filling satisfy a threshold of the super set of solution patterns.

17. The computer system of claim 13, further comprising:
determining, by the one or more processors, that the solution in the reference solution pattern repository satisfies the base control set, the determining comprising:
generating, by the one or more processors, based on applying a machine learning algorithm, a recommendation for a finalized feature list for solution patterns; and
utilizing, by the one or more processors, the finalized feature list for solution patterns to identify a match in the reference solution pattern repository.

18. The computer system of claim 17, further comprising:
based in identifying the match, generating, by the one or more processors a Zero Trust compliant design based on an existing solution pattern in the reference solution pattern repository.

19. The computer system of claim 13, further comprising:
determining, by the one or more processors, that the solution in the reference solution pattern repository does not satisfy the base control set, the determining comprising:
generating, by the one or more processors, based on applying a machine learning algorithm, a recommendation for a finalized feature list for solution patterns; and
comparing, by the one or more processors, the finalized feature list for solution patterns to the reference solution pattern repository.

20. A computer program product for generating a compliant system design for a computing architecture, the computer program product comprising:
one or more computer readable storage media and program instructions collectively stored on the one or more computer readable storage media readable by at least one processing circuit to:
ingest input data, wherein the input data comprises requirements and standards for the computing architecture;
identify relevant categorical variables in the input data by applying a machine learning algorithm, wherein the machine learning algorithm utilizes the relevant categorical variables to determine common controls in the input data;
generate, based on the common controls, a recommendation for a base control set for the computing architecture;
generate, based on the recommendation, the base control set and solution requirement specifications; and
determine, based on comparing the solution requirement specifications to a reference solution pattern repository, if a solution in the reference solution pattern repository satisfies the base control.
